(19) United States
(12) Patent Application Publication
(10) Pub. No.: US 2019/0310112 A1
(43) Pub. Date: Oct. 10, 2019

(54) CAPACITIVE SENSOR UNIT

(71) Applicant: BROSE FAHRZEUGTEILE GMBH & CO. KOMMANDITGESELLSCHAFT, BAMBERG, Bamberg (DE)

(72) Inventor: Manuel Prando, Bamberg (DE)

(73) Assignee: BROSE FAHRZEUGTEILE GMBH & CO. KOMMANDITGESELLSCHAFT, BAMBERG, Bamberg (DE)

(21) Appl. No.: 16/380,144

(22) Filed: Apr. 10, 2019

(30) Foreign Application Priority Data
Apr. 10, 2018 (DE) 102018205339.1

(51) Int. Cl. G01D 5/241

(52) U.S. Cl. CPC G01D 5/2417

(57) ABSTRACT

A capacitive sensor unit of a motor vehicle, having a first electrode, and having a second electrode which are connected to an evaluation unit. The two electrodes are connected to one another by a predetermined break point.

### CROSS-REFERENCE TO RELATED APPLICATIONS

This application claims priority to German Patent Application No. DE 10 2018 205 339.1 filed Apr. 10, 2018, the disclosure of which is incorporated in its entirety by reference herein.

### TECHNICAL FIELD

The disclosure relates to a capacitive sensor unit of a motor vehicle and to a method for manufacturing an assembly of a motor vehicle, having a capacitive sensor unit.

### BACKGROUND

In order to increase the comfort, motor vehicles increasingly have electrically operated adjustment drives. Therefore, in particular a sliding side door of a motor vehicle and tailgates are operated by an electric motor. In other words, the sliding door and/or the tailgate are/is used as an adjustment part, and when the adjustment drive is activated they are moved into an opened or closed position. In addition, approaching of the user to the motor vehicle is usually monitored by close-range sensors, and when the user approaches the motor vehicle the latter is unlocked. In order to increase the comfort further, in this case, the adjustment drive is activated by a contactless sensor which senses movement of the user. As a result, a manual operator control of the adjustment drive is not necessary, and the tailgate or sliding door can therefore be opened even if the user cannot use his hands for this purpose, for example because the user is carrying a load.

The switching element which activates the adjustment drive in this case usually comprises a capacitive sensor unit with an electrode. The capacitive sensor unit is usually arranged in the region of a rear bumper of the motor vehicle, for which reason approaching of the user to the tailgate can be sensed. So that a movement of a foot of the user can be sensed as an activation signal, it is necessary for the capacitive sensor unit to have a plurality of electrodes.

For the purpose of simplified mounting on the bumper, the electrodes are suitably already connected to an evaluation unit, with the result that the capacitive sensor unit is made available as an entirety. It is possible here that when the capacitive sensor unit is supplied and handled, the two electrodes uncontrollably catch on one another and become entangled with one another, which makes the logistics more difficult. At the worst it is also possible that the electrodes tear or become detached from the evaluation unit, which increases the rejection rate.

The disclosure is based on the object of specifying a particularly suitable capacitive sensor unit of a motor vehicle and a particularly suitable method for manufacturing an assembly of a motor vehicle, wherein mounting and/or logistics are/is advantageously simplified and the manufacturing time shortened, wherein the rejection rate is expediently reduced.

### SUMMARY

According to the disclosure, this object is achieved with respect to the capacitive sensor unit as described below, and with respect to the method as described below. Advantageous developments and refinements are the subject matter of the respective dependent claims.

The capacitive sensor unit is a component of the motor vehicle. For example, the capacitive sensor unit is a constituent element of a switching element by which an actuator of the motor vehicle is activated. Alternatively, the capacitive sensor unit may be coupled by signaling technology to the actuator. The capacitive sensor unit serves, in particular, for the contactless activation of an electromotive adjustment drive and is in particular suited, provided and/or designed for this purpose. The capacitive sensor unit may be a component of the electromotive adjustment drive. The electromotive adjustment drive has an electric motor and an adjustment part which can be moved along the adjustment path by the electric motor. The adjustment part is, for example, a side door of a motor vehicle, for example a sliding door. However, the adjustment part may be a tailgate, and the electromotive adjustment drive is therefore a tailgate which is operated by electric motor.

During operation, a user input or a user request, but at least a user activity, is sensed by the capacitive sensor, and energization of the electric motor is changed as a function thereof. In particular, the electric motor is activated as a function of the capacitive sensor unit. Consequently, no contact is necessary for the activation of the electromotive adjustment drive. The electromotive adjustment drive may be activated if approaching of the user to a specific point of the motor vehicle is sensed by the capacitive sensor unit, wherein the capacitive sensor unit itself is not contacted. Activation is understood here to mean, in particular, changing of the energization and/or setting of the adjustment drive.

The capacitive sensor unit is expediently used as a close-range sensor. The capacitive sensor unit is suitably used to activate the electromotive adjustment drive, wherein the activation of the capacitive sensor unit takes place in a contactless fashion. Activation is understood to mean, in particular, the start of an adjustment movement of the adjustment part and/or the execution of an adjustment movement. The adjustment part may be moved into an opened or into a closed position by the adjustment movement.

The capacitive sensor unit has a first electrode and a second electrode. The two electrodes are suitable, in particular provided and designed, for sensing a change in a dielectric constant in the surroundings of the capacitive sensor unit. The two electrodes can be operated independently of one another here. Therefore, in particular with one of the electrodes a specific region of the motor vehicle is monitored, and with the other electrode another region of the motor vehicle or the surroundings of the motor vehicle in the appropriate state are monitored. At the least, the electrodes may not be a component of a common capacitor but instead are each independent sensors.

In addition, the capacitive sensor unit has an evaluation unit which is connected to the two electrodes. The electrodes may be expediently connected electrically and particularly mechanically to the evaluation unit, that is to say are attached thereto. In particular, the evaluation unit is connected by signaling technology to the two electrodes, with the result that during operation measurement data of the respective electrodes can be acquired and processed by the evaluation unit. For this purpose, the evaluation unit may have a suitable electrical circuit. For example, during operation, the two electrodes are energized, in particular by an alternating current, with the evaluation unit.

The two electrodes are connected, that is to say coupled to one another, wherein the connection is implemented by a predetermined break point. The capacitive sensor unit therefore has at least two different configurations, wherein in the one configuration the two electrodes are connected to one another, and wherein in the second configuration the two electrodes are detached from one another, that is to say the predetermined break point is disconnected. In this context, the two electrodes are expediently spaced apart from one another.

If the two electrodes are connected to one another by the predetermined break point, the position of the two electrodes with respect to one another is stabilized and consequently permanently predefined. This simplifies transportation and storage of the capacitive sensor unit. By disconnecting the predetermined break point and therefore separating the two electrodes from one another it is possible to position them in different regions of the motor vehicle and adapt them to different conditions of the motor vehicle, which simplifies mounting on the motor vehicle and improves functionality.

In addition, the making available of the capacitive sensor unit during a mounting process on the motor vehicle or in the case of a component of the motor vehicle is simplified since the two electrodes do not each have to be handled separately. The connection at the evaluation unit to the electrodes makes it possible to make available the capacitive sensor as an entirety, for example in a container which is arranged next to an assembly line, wherein a plurality of such capacitive sensor units are stored in the container here. When the capacitive sensor unit is removed, snagging of the electrodes on one another or with electrodes of the other capacitive sensor units is prevented or at least reduced, with the result that the removal occurs comparatively promptly. The capacitive sensor unit is also already completely ready-mounted, with the result that a residence time of the motor vehicle or of the component of the motor vehicle next to the container can be selected to be comparatively short. Therefore, in particular such a capacitive sensor unit is used for the manufacture of a motor vehicle or a component of the motor vehicle such as an assembly of the motor vehicle. In particular, before connection to the motor vehicle or the component of the motor vehicle, the two electrodes are detached from one another. The two electrodes are expediently detached and/or spaced apart from one another in the appropriate mounted state on the motor vehicle.

For example, the electrodes of the capacitive sensor unit are essentially the same and, with the exception of any components which are necessary to make available the predetermined break point, are identical in design. As an alternative to this, the electrodes are different from one another and have, for example, a different length, different width and/or different methods of functioning. It is therefore possible for the electrodes to adapt to the desired field of application. For example, the electrodes are already connected to one another by the predetermined break point during fabrication. In this context, the two electrodes or at least some of the respective electrodes are fabricated, for example, from a single piece into which the predetermined break point is expediently introduced for the purpose of separation into the two electrodes. As an alternative to this, the two electrodes are manufactured separately from one another and connected to one another by the predetermined break point.

The disclosure also relates to a compound structure composed of a plurality of capacitive units of this type which are of identical design to one another. In this context, in particular the first electrode of one of the capacitive sensor units is connected to the second electrode of another of the capacitive sensor units by a further predetermined break point. In particular, all the electrodes of the composite structure of the capacitive sensor units or at least one comparatively large portion of the electrodes of the composite structure of the capacitive sensor units are connected to one another by one further predetermined break point in each case. This simplifies fabrication of the capacitive sensor units. For example, the capacitive sensor units which are connected to one another by the further predetermined break points are made available as meter ware, wherein each meter has, in particular, a specific number of electrodes. Firstly, all the electrodes may be fabricated as meter ware. They are connected in a further step to, in each case, one assigned evaluation unit. By disconnecting the further predetermined break points, the capacitive sensor units are made available, wherein this occurs, for example, next to the assembly line. In this way, the fabrication of the capacitive sensor units and their handling is simplified. In particular, the disclosure therefore also relates to a method for fabricating such capacitive sensor units.

For example, the capacitive sensor unit has a third, fourth or more electrodes, wherein in each case at least two of the electrodes are connected to one another by a predetermined break point. In particular, the second electrode is connected to, in each case, one predetermined break point on the first and third electrodes, wherein the first electrode and the third electrode are each connected only to the second electrode.

For example, the two electrodes are detachably connected to one another, for example in a positively locking and/or frictionally locking fashion. In particular, the connection is effected by clips and/or latching elements. In this way, comparatively simple connection of the two electrodes to one another is possible, wherein the connection is expediently detached, may be disconnected, for the purpose of mounting. However, the two electrodes may be connected to one another in a materially joined fashion. This simplifies manufacture and handling of the capacitive sensor unit. For example, in this context the two electrodes are fabricated from one piece, into which the predetermined break point is introduced in a further working step in order to form the two electrodes.

The two electrodes may be pliable, that is to say in particular not rigid. In this context, the predetermined break point is particularly may be formed by a perforation. Owing to the materially joined connection of the pliable electrodes, handling is comparatively simple and uncontrolled movement of the electrodes is essentially prevented owing to the enlarged extent of the composite structure of the two electrodes. By the perforation, division is comparatively easily possible, in particular by hand or by a blade. In this context, owing to the perforation, the predetermined break point can be perceived easily. Alternatively, the predetermined break point is implemented by continuous tapering. In other words, in the region of the predetermined break point the material has a reduced thickness which may be selected such that the two electrodes can be separated manually along the predetermined break point, in particular by mounting gloves.

For example, the two electrodes are formed by a foil or have at least one such foil. The two electrodes are, for example, ribbon cables or each have a ribbon cable. For example, the two electrodes are embodied as a flexible circuit board or each have such a flexible circuit board. The two electrodes are fastened to the evaluation unit, that is to say, in particular, the two pliable electrodes are fastened to the evaluation unit and therefore stabilized. For example, the evaluation unit also has a flexible circuit board which is fabricated from the same material as the two electrodes. The evaluation unit and the two electrodes may be fabricated in one working step as a flexible circuit board, wherein in particular the perforation is introduced between the two electrodes. Owing to the composite structure, handling of the capacitive sensor unit is further simplified. By disconnecting the perforation and therefore separating the two electrodes from one another it is possible to position them in different regions of the motor vehicle and adapt them to different conditions of the motor vehicle, with the result that mounting on the motor vehicle and a functionality are improved.

A tearing aid may adjoin the end side of the perforation. The tearing aid is for example made available by edge-side recess, in particular an area of abraded material. Suitably, the tearing aid is triangular, wherein a tip of the triangle expediently merges with the perforation or at least points thereto. The tearing aid simplifies separation of the predetermined break point, that is to say the movement of the two electrodes away from one another. Machine separation, in particular during automated mounting of the capacitive sensor unit, is also possible, for example by a fixed blade. The tearing aid is, for example, independent of the perforation.

In a further alternative, each of the two electrodes has a plastic carrier, which carriers are, for example, of identical design to one another. Each plastic carrier particularly may have a receptacle by which a cable or a stranded conductor is held. In particular, the cable or the stranded conductor is arranged in the receptacle. In other words, the plastic carrier may have the receptacle for the cable or the stranded conductor. The receptacle is formed here, for example, by a groove or an undercut. The plastic carrier expediently comprises a number of such receptacles, for example grooves, which are, for example, parallel to one another. The plastic carriers may be extruded, that is to say expediently manufactured using an extrusion method. The plastic carriers are alternatively fabricated by another method.

In particular, each plastic carrier is spaced apart from the evaluation unit. The predetermined break point is expediently formed by an adhesive layer, that is to say in particular a slightly adhesive intermediate substrate such as glue. The adhesive layer is, for example, an adhesive which is applied to one of the plastic carriers, in particular in the liquid state. As an alternative to this, an adhesive tape, in particular a double-sided adhesive tape, is used to make available the adhesive layer. In another alternative, the predetermined break point is also formed by plastic, and the two plastic carriers are extruded as one piece, wherein the predetermined break point is made available by a comparatively thin web.

The two electrodes may extend along a main direction of extent. In this context, the extent of the electrodes along the main direction of extent is greater than twice, three times, four times, five times, ten times or twenty times the extent in a different direction which is perpendicular to the main direction of extent. Any connections of the electrode may be located at the end side in the main direction of extent. Owing to the end-side arrangement of the connections of the electrodes, simple connection to the evaluation electronics is made possible. The connections of the electrodes may be fastened to the evaluation unit or at least connected thereto.

The predetermined break point particularly may run parallel to the main direction of extent. In this context, the two electrodes, if connected to one another by the predetermined break point, are for example arranged one on top of the other. However, the two electrodes may be arranged only in a single plane, and the predetermined break point particularly may run along the entire extent of the two electrodes along the main direction of extent. In this context, the two electrodes may be arranged congruently perpendicularly with respect to the main of direction extent and/or have the same extent along the main direction of extent.

In an alternative configuration of the disclosure, the two electrodes are connected to one another at the end side in the main direction of extent by the predetermined break point, and the predetermined break point runs, for example, perpendicularly with respect to the main direction of extent. Therefore, in particular a different selection of the length of the electrodes when the predetermined break point is separated is made possible. In other words, the predetermined break point is shifted along the main direction of extent. However, the two electrodes particularly may have the same extent along the main direction of extent and are therefore equally long.

Expediently, each electrode has an electrical conductor which is at least partially or completely formed, for example, by the cable/the stranded conductor or some other conductor tracks of a flexible circuit board. The electrical conductor may be soldered to a circuit board of the evaluation unit. The electrodes and the evaluation unit are therefore rigidly fastened to one another, with the result that mounting of the capacitive sensor unit is simplified. Also no further components are necessary, which reduces manufacturing costs. In an alternative configuration, the electrical conductor has at the end side a plug which is plugged, in particular, into a corresponding mating part of the circuit board. Detachment of the electrodes from the evaluation unit is therefore made possible. Alternatively, an insulation displacement contact is used for forming contact.

The circuit board expediently has electrical and/or electronic components, for example a microprocessor. In particular, the circuit board comprises an electrical circuit by which measurement signals of the electrodes are sensed and/or evaluated.

The electrical conductor may be configured in the form of a loop. In other words, the ends of the electrical conductor are located on the same side of the electrode. In this way, connection to the evaluation unit is simplified. Owing to the loop form, in addition sensitivity to the electrode is increased. In this context, in particular the electrical conductor is configured in the form of a loop independently of the soldering to the circuit board and has, for example, a plug on this side. Alternatively, the conductor is not in the form of a loop and is, in particular, linear.

The method serves to manufacture an assembly of a motor vehicle. In other words, in the appropriate state the assembly is a component of the motor vehicle. For example, the assembly can be seen from outside the motor vehicle or is concealed by further components of the motor vehicle. The assembly may be a bumper of the motor vehicle, in particular a rear bumper of the motor vehicle. As an alternative to this, the assembly is a door module or comprises a door module. For example, the assembly has an adjustment drive, in particular an electromotive adjustment drive, such as an electromotive window lifter, a tailgate which is operated by electric motor or a door which is operated by electric motor, such as a side door.

The method provides that a capacitive sensor unit is made available which has a first electrode and a second electrode which are connected to an evaluation unit, wherein the two electrodes are connected to one another by a predetermined break point. In addition, a carrier is made available. The carrier is suitably embodied in a rigid fashion or is essentially rigid. However, the camera is at least comparatively stiff. The carrier may be in one piece. The carrier is, in particular in the appropriate state, a component of bodywork of the motor vehicle, that is to say can be seen from outside the motor vehicle and is therefore a component of an outer skin of the motor vehicle. As an alternative to this, in the appropriate state the carrier is mounted underneath the outer skin of the motor vehicle, and the outer skin may be connected to the carrier subsequent to the method or as a last working step of the method. The outer skin may be produced from a metal or plastic and is provided with a coating, or there is at least provision for it to be provided with a coating. The capacitive sensor unit and the carrier are, for example, made available simultaneously. The fabrication of the carrier suitably takes place independently of the fabrication of the capacitive sensor unit.

In a further working step, the first electrode is detached from the second electrode. In addition, in a further working step the first electrode is connected to the carrier, for example fastened thereto, and in another working step the second electrode is connected to the carrier, for example fastened thereto. The connection is carried out, for example, by clipping or an adhesive. Alternatively, or in combination therewith, a positively locking connection is formed between the electrodes and the carrier, wherein, for example, the same or different fastening methods are used for the two electrodes. For example, the connection of the two electrodes to the carrier occurs simultaneously. As an alternative to this, the first electrode is connected to the carrier, and subsequently the second electrode is detached from the first electrode and connected to the carrier. However, the separation of the first electrode from the second electrode always takes place at least only subsequent to the capacitive sensor unit being made available.

Owing to the detachment of the two electrodes from one another after the capacitive sensor unit has been made available, snagging of the two electrodes before the capacitive sensor unit is made available is prevented and therefore the logistics and handling of the capacitive sensor unit are simplified. The rejection rate is also reduced. In addition, the capacitive sensor units can be inserted into machines with reproducible precision for further processing or test arrangements.

In a further working step, the evaluation unit of the capacitive sensor unit may be connected to the carrier. The connection in particular takes place in a positively locking and/or frictionally locking fashion. Alternatively, or in combination therewith, the connection is carried out by an adhesive. The connection of the evaluation unit occurs, for example, chronologically before, chronologically after or at the same time as the connection to at least one of the two electrodes. A housing of the evaluation unit or the circuit board, which happens to be present, of the evaluation unit may be connected, for example bonded, to the carrier. In this way, detachment of the evaluation unit from the electrodes is prevented owing to the stabilization by the same carrier.

For example, the adjustment drive is subsequently mounted on the carrier. Alternatively, the adjustment drive is mounted on the carrier before the connection of the capacitive sensor unit. The adjustment drive is expediently connected by signaling technology to the capacitive sensor unit. However, the capacitive sensor unit may be connected by signal technology at least to further components of the motor vehicle, such as a bus system, for example a CAN bus system or a LIN bus system, or a single signal line or a plurality of lines.

The developments and advantages which are implemented in conjunction with the capacitive sensor unit are correspondingly also transferred to the method, and vice versa.

### BRIEF DESCRIPTION OF THE DRAWINGS

Exemplary embodiments of the disclosure are explained in more detail below with reference to a drawing, in which:

FIG. 1 shows a simplified schematic view of a tailgate which is operated by electric motor and has a capacitive sensor unit,

FIGS. 2 and 3 each show in a plan view a first embodiment of the capacitive sensor unit,

FIGS. 4 and 5 each show in a plan view a second embodiment of the capacitive sensor unit,

FIG. 6 shows a method for manufacturing an assembly of a motor vehicle, and

FIG. 7 shows a perspective view of the assembly with the capacitive sensor unit.

Parts which correspond to one another are provided with the same reference symbols in all the figures.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

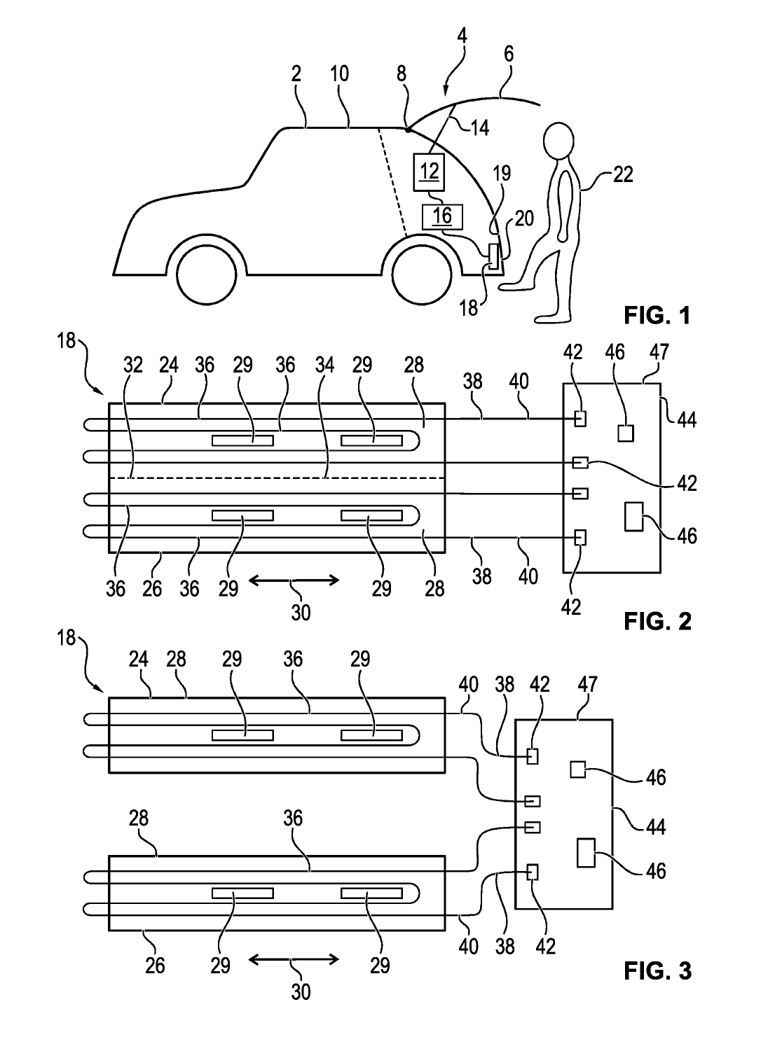

FIG. 1 is a schematically simplified illustration of a motor vehicle 2 with an (electromotive) adjustment drive 4 in the form of a tailgate which is operated by electric motor. The tailgate 4 which is operated by electric motor has a flap 6 which is pivotably mounted on bodywork 10 of the motor vehicle 2 by a hinge 8. The tailgate 4 which is operated by electric motor also comprises an electric motor 12 which is also fastened to the bodywork 10. A length-variable activation part 14, such as a spindle or a cylinder, is driven by the electric motor 12 and is fastened at one end to the flap 6 and at the other to the bodywork 10. Consequently, the flap 6 can be pivoted from an open position into a closed position and from a closed position into an open position by operation of the electric motor 12. The electric motor 12 is controlled by a control unit 16 which is connected by signaling technology and electrically to the electric motor 12. In this context, the energization of the electric motor 12 is set by the control unit 16.

In addition, the tailgate 4 which is operated by electric motor comprises a capacitive sensor unit 18 which is fastened to the inside of an outer skin 19 of a rear bumper 20 of the bodywork 10. The capacitive sensor unit 18 is coupled by signal technology to the control unit 16 and operates according to a capacitive principle. In so far as a user 22 moves his foot in the region of the bumper 20, wherein the foot remains spaced apart from the bodywork 10, this is sensed by the capacitive sensor unit 18 on the basis of a change in the dielectric constant in the surroundings of the bumper 20. This sensor signal is evaluated by the control unit 16 and interpreted as a user input or user request. Subsequent to this, the electric motor 12 is energized, with the result that the flap 6 is pivoted. In other words, the capacitive sensor unit 18 serves for contactless activation of the tailgate 4 which is operated by electric motor.

FIG. 2 and FIG. 3 each show a plan view of the capacitive sensor unit 18, wherein different configurations are illustrated in the two figures. FIG. 2 shows the capacitive sensor unit 18 after its fabrication and FIG. 3 shows the capacitive sensor unit 18 before its installation and fastening to the outer skin 19 of the bumper 20. The capacitive sensor unit 18 has a first electrode 24 and a second electrode 26 which each have an extruded plastic carrier 28. The two plastic carriers 28 are identical in design and have a plurality of openings 29 for mounting on the outer skin 19. The plastic carriers 28 and therefore also the electrodes 24, 26 extend along a main direction of extent 30 and are connected to one another by a predetermined break point 32. The predetermined break point 32 is an adhesive layer 34 which runs along the sides, facing one another, of the plastic carriers 28 and is parallel to the main direction of extent 30. In this context, the main direction of extent 30 is also the direction along which the plastic carriers 28 were extruded and along which the plastic carriers 28 have the greatest extent. In summary, the two electrodes 24, 26 are connected to one another in a materially joined fashion.

Each of the plastic carriers 28 has a plurality of grooves 36 within each of which a stranded conductor 38 which is positioned in the form of a loop is arranged. The stranded conductor 38 is therefore an electrical conductor 40. The electrical conductor 40 is positioned in the form of a loop, wherein two loops are formed. The electrical conductor 40 therefore ends in each case on a single side of the plastic carrier 28. The ends of the electrical conductors 40 are each soldered to connection pads 42 of the circuit board 44. The circuit board 44 has a base body which is fabricated from a glass-fiber-reinforced epoxy resin to which conductor tracks, for example made of copper, are connected. The circuit board 44 also comprises further electrical and/or electronic components 46 which are placed in electrical contact with the connection pads 42 by the conductor tracks (not illustrated in more detail). The circuit board 44 and the electrical and/or electronic components 46 are a component of an evaluation unit 47 by which the measurement data which is made available by the electrodes 24, 26 is evaluated during operation. In summary, the two electrodes 24, 26 are connected to the evaluation unit 47 by signaling technology and electrically and mechanically.

In order to mount the capacitive sensor unit 18, the predetermined break point 32 is disconnected so that the two electrodes 24, 26 can be spaced apart from one another, as is shown in FIG. 3. It is also possible here to pivot the main direction of extent 30 of the two electrodes 24, 26 with respect to one another owing to the elastic/plastic deformability of the stranded conductors 38, with the result that they are no longer arranged parallel to one another. Here, the stranded conductors 38 also continue to be held within the plastic carriers 28 by the grooves 36.

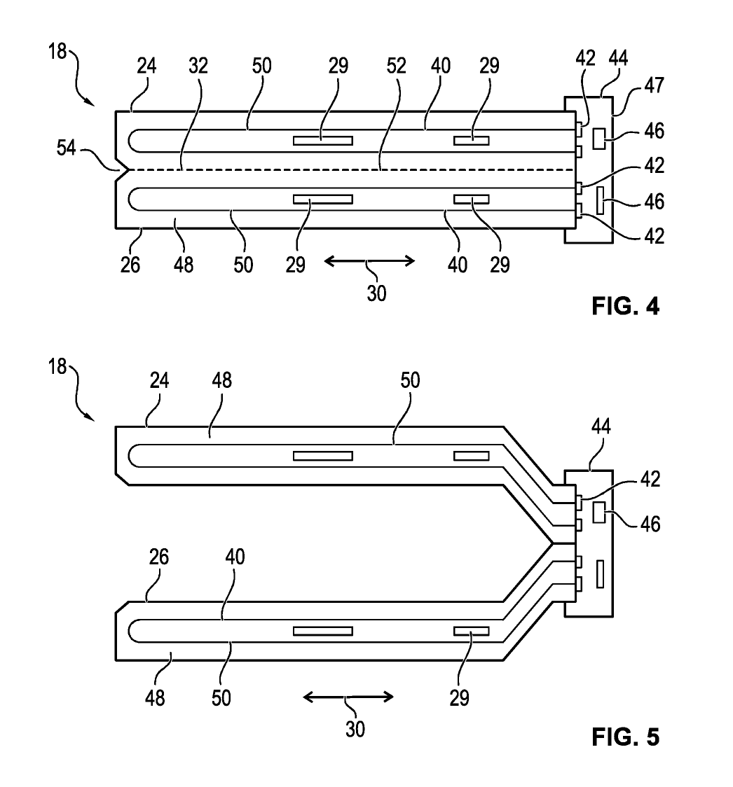

FIGS. 4 and 5 show an alternative configuration of the capacitive sensor unit 18 corresponding to FIGS. 2 and 3. This embodiment also has the first and second electrodes 24, 26 which are fastened to one another by the predetermined break point 32. In this context, the first electrode 24 and the second electrode 26 are configured as a flexible circuit board and are therefore pliable. The electrical conductor 40 is implemented by a conductor track 50 which is printed onto a foil 48. The predetermined breaking point 32 is formed by a perforation 52. In other words, the foil 48 is perforated in the region of the predetermined break point 32. The perforation 52 itself runs in turn along the main direction of extent 30 and opens, at one end, into a tearing aid 54 which therefore adjoins the perforation 52 at one end. The two electrodes 24, 26 are configured to have axial symmetry with respect to the predetermined break point 32, that is to say with respect to the perforation 52.

The evaluation unit 47 is, on the other hand, not modified and has in turn the electrical and/or electronic components of the circuit board 44. The conductor tracks 50 of the two electrodes 24, 26 are also in electrical contact with the connection pads 42 of the circuit board 44. Consequently, the electrical conductor 40 in the form of the conductor track 50 of the respective electrodes 24, 26 is in turn soldered to the circuit board 44 of the evaluation unit 47. The electrical conductor 40 is in turn configured in the form of a loop, wherein in this exemplary embodiment in each case just a single loop is present. In a configuration of the disclosure which is not illustrated in more detail, the circuit board 44 is also configured as a flexible circuit board and in one piece with the electrodes 24, 26 and consequently also has the foil 48. In this case, the conductor tracks 50 are essentially connected integrally to the circuit board 44.

In order to mount the capacitive sensor unit 18, the perforation 52 is separated, for which the tearing aid 54 is used. For example, a blade or the like is inserted into the tearing aid 54 and moved along the main direction of extent 30 with respect to the electrodes 24, 26. It is therefore possible to space apart the two electrodes 24, 26 perpendicularly with respect to the main direction of extent 30, as shown in FIG. 5. Therefore, two strips of the foil 48 are now present. The fastening to the outer skin 19 of the bumper 20 takes place by the openings 29 of the two electrodes 24, 26. In this context, clips or the like are guided through the openings 29 and fastened to the outer skin 19 or to another component of the bumper 20. Owing to the pliable configuration of the electrodes 24, 26 positioning on the outer skin 19 according to requirements is possible.

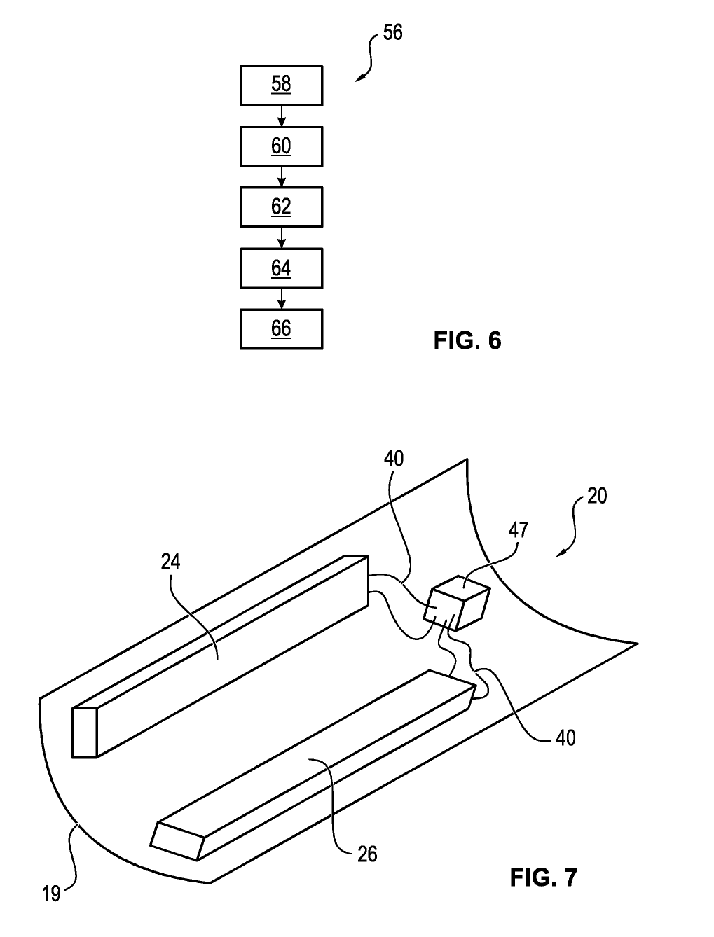

FIG. 6 illustrates a method 56 for manufacturing the bumper 20 which is an assembly of the motor vehicle 2 and which is shown in schematically simplified form from the inner side in FIG. 7. The method 56 can also be used here for fabricating a door module or the like. In a first working step 58, the capacitive sensor unit 18 is made available with the first electrode 24 and with the second electrode 26 which are connected to the evaluation unit 47. In this context, the two electrodes 24, 26 are connected to one another by the predetermined break point 32. The outer skin 19 is made available in a second working step 60 which takes place, for example, simultaneously, said outer skin 19 therefore forming a carrier. The outer skin 19 is an injection-molded a plastic part which is provided on the outside with a surface coating.

In a subsequent third working step 62, the first electrode 24 is detached from the second electrode 26, and the predetermined break point 32 is therefore separated. In a directly subsequent fourth working step 64, the first electrode 24 and the second electrode 26 are connected to the inner side of the outer skin 19. For this purpose, clips which are not illustrated in more detail are guided through the openings 29 and fastened to the outer skin 19. In a subsequent fifth working step 66, the evaluation unit 47 is also fastened to the inner side of the outer skin 19.

In summary, the electrodes 24, 26 are ribbon cable elements. These are not connected to one another individually, but rather longitudinally, that is to say along the main direction of extent 30, via the predetermined break point 32. Therefore, the two electrodes 24, 26 can be used as one part and be disconnected directly before or during the mounting on the carrier 19. For example, a slightly adhesive intermediate substrate, in particular glue, is introduced between the two electrodes 24, 26, with the result that the two electrodes 24, 26 can be separated on an assembly line of the bumper 20.

Owing to the capacitive sensor unit 18, simplified handling is provided since the electrodes 24, 26 do not snag on one another and there are few degrees of freedom in the geometry of the capacitive sensor unit 18. In this way, a machine process is possible which provides reproducible precision. An accelerated handling owing to the temporary reduction of the movable parts is provided since the two electrodes 24, 26 are stabilized with respect to one another.

Owing to the tearing aid 54, disconnection of the electrodes 24, 26 which are ribbon cable elements at the predefined point, that is to say along the predetermined break point 32, is facilitated. The start of the predetermined break point 32, that is to say the start of the intended tear, is therefore also marked. The predetermined break point 32 is separated, for example, by pulling and/or shearing, and the two electrodes 24, 26 may be mounted separately. In a further configuration, a plurality of capacitive sensor units 18 are present which are present as a roller or matt. In this context, all the electrodes 24, 26 are connected to one another and may be made available by a single matt or a single roller. The main direction of extent 30 of the electrodes 24, 26 is perpendicular to the main direction of extent of the matt/parallel to the axis of the roller here. The individual capacitive sensor units 18 are produced by disconnecting the matt/roller. The respective electrodes 24, 26 may be connected to one another by a further predetermined break point, between respectively adjacent capacitive sensor units 18.

The invention is not limited to the exemplary embodiments described above. Instead, other variants of the invention can also be derived therefrom by a person skilled in the art without departing from the subject matter of the invention. In addition, in particular all the individual features described in conjunction with the individual exemplary embodiments can also be combined with one another in some other way without departing from the subject matter of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF REFERENCE NUMBERS

2 Motor vehicle
4 Adjustment drive
6 Flap
8 Hinge
10 Bodywork
12 Electric motor
14 Length variable activation part
16 Control unit
18 Capacitive sensor unit
19 Outer skin
20 Bumper
22 User
24 First electrode
26 Second electrode
28 Plastic carrier
29 Opening
30 Main direction of extent
32 Predetermined break point
34 Adhesive layer
36 Groove
38 Stranded conductor
40 Electrical conductor
42 Connection pad
44 Circuit board
46 Electrical/electronic component
47 Evaluation unit
48 Foil
50 Conductor track
52 Perforation
54 Tearing aid
56 Method
58 First working step
60 Second working step
62 Third working step
64 Fourth working step
66 Fifth working step

What is claimed is:

1. A capacitive sensor unit of a motor vehicle, comprising: a first electrode, and having a second electrode which are connected to an evaluation unit, wherein the first and second electrodes are connected to one another by a predetermined break point.

2. The capacitive sensor unit as claimed in claim 1,
wherein
the first and second electrodes are connected to one another in a materially joined fashion.

3. The capacitive sensor unit as claimed in claim 2,
wherein
the first and second electrodes are pliable, and wherein the predetermined break point is formed by perforation.

4. The capacitive sensor unit as claimed in claim 3,
wherein
a tearing aid adjoins the end side of the perforation.

5. The capacitive sensor unit as claimed in claim 2,
wherein
the first and second electrodes each have an extruded plastic carrier, and wherein the predetermined break point is formed by an adhesive layer.

6. The capacitive sensor unit of claim 1,
wherein
the first and second electrodes extend along a main direction of extent, and wherein the predetermined break point is parallel to the main direction of extent.

7. The capacitive sensor unit of claim 1,
wherein
each electrode has an electrical conductor which is soldered to a circuit board of the evaluation unit.

8. The capacitive sensor unit as claimed in claim 7,
wherein
the electrical conductor is loop-shaped.

9. A method for manufacturing an assembly of a motor vehicle with a capacitive sensor unit comprising:
connecting a first electrode and a second electrode of the capacitive sensor unit to an evaluation unit;
connecting a first and second electrode to a predetermined break point;
detaching the first electrode from the second electrode;
connecting the first electrode to a carrier; and the second electrode is connected to the carrier.

10. The method as claimed in claim 9,
wherein
the evaluation unit is connected to the carrier.

11. A capacitive sensor unit, comprising:
a first electrode; and
a second electrode connected to an evaluation unit, wherein the first and second electrode are connected via a predetermined break point that includes an adhesive layer running along sides of a plastic carrier of the capacitive sensor unit.

12. The capacitive sensor unit of claim 11, wherein the first electrode is connected to a circuit board via a first conductor and the second electrode is connected to a circuit board via a second conductor.

13. The capacitive sensor unit of claim 11, wherein the first and second electrode is connected to a circuit board via a conductor.

14. The capacitive sensor unit of claim 13, wherein the circuit board includes one or more connection pads.

15. The capacitive sensor unit of claim 13, wherein, the predetermined break point is parallel to a main direction of extent of the capacitive sensor unit.

16. The capacitive sensor unit of claim 11, wherein the first and second electrode are arranged on a single plane.

17. The capacitive sensor unit of claim 11, wherein the first and second electrode are ribbon cable elements.

18. The capacitive sensor unit of claim 11, wherein the first and second electrode are ribbon cable elements.

19. The capacitive sensor unit of claim 11, wherein the evaluation unit is configured to measure data made available by the first and second electrodes.

20. The capacitive sensor unit of claim 11, wherein the plastic carrier includes one or more grooves holding one or more stranded conductors.
